(19) United States
(12) Patent Application Publication
(10) Pub. No.: US 2010/0098340 A1
(43) Pub. Date: Apr. 22, 2010

(54) Method And A System For Lenticular Printing

(76) Inventors: Assaf Zomet, Jerusalem (IL); Shmuel Peleg, Mevasseret Zion (IL); Ben Denon, Tzur-Yigal (IL)

Correspondence Address: MARTIN D. MOYNIHAN d/b/a PRTSI, INC., P.O. BOX 16446, ARLINGTON, VA, 22215, US

(21) Appl. No.: 12/448,894

(22) PCT Filed: Jan. 15, 2008
(86) PCT No.: PCT/IL08/00060

§ 371 Date: Jul. 14, 2009

Related U.S. Application Data
(60) Provisional application No. 60/884,953, filed on Jan. 15, 2007.
(60) Provisional application No. 60/891,512, filed on Feb. 25, 2007.
(60) Provisional application No. 60/951,242, filed on Jul. 23, 2007.
(60) Provisional application No. 61/006,363, filed on Jan. 8, 2008.

(51) Int. Cl. G06K 9/52

(52) U.S. Cl. 382/206

(57) ABSTRACT

A method of selecting images for lenticular printing. The method comprises receiving a sequence having a plurality of images, selecting a segment of the sequence according to one or more lenticular viewing measures, and outputting the segment for allowing the lenticular printing.

### FIELD AND BACKGROUND OF THE INVENTION

The present invention, in some embodiments thereof, relates to lenticular printing and, more particularly, but not exclusively, to an apparatus and a method for enhancing lenticular printing.

Lenticular printing is a process consisting of creating a lenticular image from at least two existing images, and combining it with a lenticular lens. This process can be used to create a dynamic image, for example by offsetting the various layers at different increments in order to give a three dimension (3D) effect to the observer, various frames of animation that gives a motion effect to the observer, a set of alternate images that each appears to the observer as transforming into another. Once the various images are collected, they are flattened into individual, different frame files, and then digitally combined into a single final file in a process called interlacing.

Lenticular printing to produce animated or three dimensional effects as a mass reproduction technique started as long ago as the 1940s. The most common method of lenticular printing, which accounts for the vast majority of lenticular images in the world today, is lithographic printing of the composite interlaced image directly onto lower surface of the lenticular lens sheet.

A number of methods and systems are known for enhancing the lenticular printing process. For example, U.S. Pat. No. 5,737,087 filed on Dec. 11, 1995 describes a method and apparatus for forming a hard copy motion image from a video motion sequence recorded on a video recording device. The video motion sequence is played and an operator selects a series of motion containing views which are stored in memory. An integral image is printed on a printing medium such that the selected motion containing views can be viewed in sequence by altering the angle between a viewer's eyes and a lenticular or barrier screen located on the printing medium.

Another example is provided in U.S. Pat. No. 6,198,544, filed on Apr. 8, 1998, that discloses a system for forming a motion card from frames of video selected by a user from a sequence of video frames that have been previously recorded on a video tape incorporates a kiosk that contains a video tape player, a processor receives a sequence of video frames from the video tape player, a display is used to display a selected range of video frames received by the processor, and step-by-step interactive instructions for the user for enabling the user to select video frames from the displayed selected range of video frames for preview display is improved by enabling the processing and display of video frames as if they were formed on the motion card so as to provide a high degree of correspondence between the displayed motion card and the to be formed motion card. A viewable simulation of the adjacency effect that will be present in the formed motion card enables the operator to improve the selection of the frames to be used in the formed motion card. Additionally, editing software enables the user to reselect video frames from the selected sequence of video frames so as to effectively change the content of the displayed motion card to meet the user's taste. A printer and a laminator, located in the kiosk or in communication with the kiosk, are used to print the selected frames in an interleaving manner, on a card sheet and for laminating a lenticular sheet over the interleaved printing so as to provide a motion card that replicates the motion image previewed on the display. U.S. Pat. No. 6,532,690, filed on U.S. Pat. No. 6,532,690 discloses an article having a lenticular image formed thereon and a sound generating mechanism associated therewith for generating a sound message, the sound message being coordinated with respect to movement of the article. A mechanism for moving the lenticular image along a predetermined path may also be provided and for coordinating the sound message with the movement of the lenticular image. Different sound segments may be activated with respect to the line-of-sight or distance of the observer with respect to the lenticular image.

### SUMMARY OF THE INVENTION

According to an aspect of some embodiments of the present invention there is provided a method of selecting images for lenticular printing. The method comprises receiving a sequence having a plurality of images, selecting a segment comprising at least some of the plurality of images according to at least one lenticular viewing measure, and outputting the segment for allowing the lenticular printing.

Optionally, the method further comprises weighting a plurality of segments of the sequence before b), each the segment being weighted according to the compliance thereof with the at least one lenticular viewing measure, the selecting being performed according to the weighting.

Optionally, the method further comprises selecting a plurality of lenticular viewing measures related to a lenticular viewing before b), each the segment being weighted according to the compliance thereof with each the lenticular viewing measure, the selecting being performed according to the weighting.

More optionally, wherein each one of the lenticular viewing measures having a predefined weight, the compliance being weighted according to respective the predefined weight.

Optionally, the method further comprises aligning the plurality of images before b).

Optionally, the at least one lenticular viewing measure comprises a member selected from a group that comprises a dynamics measure, a content measure, and a quality measure.

More optionally, wherein the selected member is the content measure, b) further comprises selecting the segment according to a member selected from a group that comprises a presence of a face in at least one image of the segment, a presence of an object with predefined characteristics in at least one image of the segment, a presence of a body organ in at least one image of the segment, and a presence of an animal in at least one image of the segment.

Optionally, the method comprises learning at least one characteristic of an object and the at least one lenticular viewing measure comprises a presence of the object and b) comprises identifying the at least one characteristic in at least one image of the segment.

Optionally, the selected member is the dynamics measure; b) further comprises identifying a motion above a predefined threshold in at least one image of the segment.

More optionally, b) further comprises identifying an object having predefined characteristics, the motion being related to the object.

More optionally, the selected member is the quality measure, b) further comprises selecting the segment according to a member selected from a group that comprises a blurring level of at least one image of the segment, an image sharpness level of at least one image of the segment, and an image brightness level of at least one image of the segment.

Optionally, thereby allowing interlacing images of the segment to create an interlaced image for the lenticular printing.

Optionally, the method further comprises adjusting at least one image of the segment according to at least one lenticular lens used in the lenticular printing after c).

More optionally, the adjusting comprises selecting a subset of the images of the segment according to a quality criterion, the subset being used for creating an interlaced image for the lenticular printing.

More optionally, the selected member is the quality measure, b) further comprises probing a plurality of segments, further comprising for each the segment emulating a blur of a lenticular image generated from at least one image of the segment and weighting the blur, b) further comprising selecting the segment according to the weighted blur.

More optionally, the blur is a member selected from a group that comprises a blur caused by a prospective lenticular lens of the lenticular image and an estimated quality of printing of an interlaced image generated from the at least one image.

More optionally, the selected member is the quality measure, further comprising identifying a calibration value configured for calibrating a prospective lenticular lens with an interlaced image generated from at least one image of the segment, using the calibration value for defining the quality measure.

More optionally, the method further comprises allowing a user to select a sub-sequence comprising at least some of the plurality of images before b), the selecting being performed from the sub-sequence.

More optionally, the method further comprises allowing the user to select at least one anchor image from the plurality of images, the selecting being performed with reference to the at least one anchor image.

More optionally, the method further comprises aligning the images of the segment after b).

More optionally, the method further comprises the aligning comprises emulating a blur of a lenticular image generated from at least one image of the segment, the aligning further comprising aligning the images of the segment according to the effect of the emulated blur thereon.

More optionally, the blur is a member selected from a group that comprises a blur in a predefined viewing distance, a blur caused by a prospective lenticular lens of the lenticular image, an estimated quality of printing of an interlaced image generated from the at least one image of the segment, and an estimated quality of the lamination of the interlaced image.

Optionally, the selecting comprises matching a plurality of segments of the sequence with a set of preferred segments. One or more of the set of preferred segments complies with respective at least one lenticular viewing measure. The segment is selected from the plurality of segments according to the matching.

According to an aspect of some embodiments of the present invention there is provided an apparatus for creating an interlaced image for lenticular printing. The apparatus comprises an input unit configured for receiving a sequence having a plurality of images, a preference module configured for selecting at least one lenticular viewing measure, a selection module configured for selecting a segment of the sequence according to the lenticular viewing measure, and an interlacing module configured for interlacing at least two images of the segment to an interlaced image for lenticular printing.

Optionally, the apparatus further comprises a database that stores a plurality of preferred segments. One or more of the plurality of preferred segments complies with respective at least one lenticular viewing measure. The selection module is configured for using the plurality of preferred segments for the selecting.

According to an aspect of some embodiments of the present invention there is provided a method for creating an interlaced image for lenticular printing. The method comprises a) receiving a plurality of images, b) automatically aligning at the plurality of images using a non-rigid transformation, and c) outputting the aligned plurality of images for allowing the lenticular printing.

Optionally, aligning is performed so as to improve lenticular printed image quality.

Optionally, the method further comprises emulating a blur of a lenticular image generated from at least some of the plurality of images before b), the automatically aligning being performed while considering the blur.

Optionally, the blur is a member selected from a group that comprises a blur caused by a prospective lenticular lens of the lenticular image and an estimated quality of printing of an interlaced image generated from the plurality of images.

Optionally, the method further comprises extending the field of view of at least one of the images before c).

According to an aspect of some embodiments of the present invention there is provided a method of selecting images for lenticular printing. The method comprises a) receiving a sequence having a plurality of images at a first network node, b) identifying a segment of the sequence according to at least one lenticular viewing measure, and c) sending the segment to a second network node for allowing the lenticular printing.

Optionally, the first network node is a server and the second network node being a client terminal having a user interface.

Optionally, the identifying is performed by a third network node.

More optionally, the first network node is a client terminal having a user interface, the second network node being a lenticular printing unit, and the third network node being a processing unit.

More optionally, the method further comprises allowing a user to use the user interface for selecting the at least one lenticular viewing measure.

Optionally, the method further comprises allowing a user to use the user interface for selecting at least one anchor image from the plurality of images, the identifying being performed with reference to the at least one anchor image.

Optionally, the method further comprises using user interface for displaying the segment to a user and receiving a conformation for the displayed segment before c).

Optionally, the method further comprises allowing a user to select the at least one lenticular viewing measure.

Optionally, the first network node is a client terminal having a user interface server and the second network node is a server.

According to an aspect of some embodiments of the present invention there is provided an article for lenticular viewing that comprises at least one lenticular lens and an interlaced image which is configured according to a blur caused by the lenticular lens, an estimated quality of printing of a printer used for printing the interlaced image, and/or an estimated quality of the lamination of the interlaced image.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method, the apparatus, and/or system of embodiments of the invention can involve performing or completing selected tasks manually, automatically, or a combination thereof. Moreover, according to actual instrumentation and equipment of embodiments of the method, the apparatus, and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method, apparatus and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an apparatus for creating an interlaced image for lenticular printing, according to some embodiment of the present invention;

FIG. 2 is a flowchart of a method for selecting a plurality of images for lenticular printing, according to some embodiment of the present invention;

FIG. 3 is a flowchart of a method for selecting a segment of sequence for lenticular printing, according to some embodiments of the present invention;

FIG. 4 is a sectional view of an exemplary array of lenticular lenses and an array of physical pixels which is printed on the back side of the lenticular lenses;

FIG. 5 is a flowchart of an exemplary process for selecting a segment of a sequence for lenticular printing, according to some embodiments of the present invention;

FIG. 6 is a calibration pattern for identification one or more calibration values for defining quality measures, according to some embodiments of the present invention;

FIG. 7 is a set of schematic illustrations of exemplary templates for the calibration pattern of FIG. 6, according to some embodiments of the present invention;

FIG. 8 is a flowchart of a method for generating an interlaced image for a lenticular image, according to some embodiments of the present invention;

FIG. 9 is a flowchart depicting a cost function for aligning a series of images, such as the images of the segment which is described in FIG. 1, according to some embodiments of the present invention;

FIG. 10 is a schematic illustration of a system for generating a dynamic image, according to some embodiments of the present invention;

FIG. 11 is a schematic illustration of a user interface that allows a user to select one of the automatically detected segments, according to some embodiments of the present invention; and

FIG. 12 is a flowchart of a method for generating a dynamic image, according to some embodiments of the present invention.

### DESCRIPTION OF SPECIFIC EMBODIMENTS OF THE INVENTION

The present invention, in some embodiments thereof, relates to lenticular printing and, more particularly, but not exclusively, to an apparatus and a method for enhancing lenticular printing.

According to an aspect of some embodiments of the present invention, there is provided an apparatus and a method of selecting images for lenticular printing. The apparatus and the method allows the identification of one or more segments of the sequence that complies with lenticular viewing measures which define characteristics of a segment that is suitable for creating a preferred lenticular image. As used herein, a to preferred lenticular image is an image that complies with quality measurements, such as sharpness and/or brightness, dynamics measurements, such as local and/or global motion, and content measurements, such as the presence of a human face or a pet in the images of the sequence. The method comprises receiving a sequence, such as a video sequence, and selecting a segment of the sequence according to one or more lenticular viewing measures, and outputting the segment for allowing the lenticular printing.

According to another aspect of some embodiments of the present invention there is provided a method for creating an interlaced image for lenticular printing that includes the aligning of the interlaced images while considering the blur and/or geometry which caused by the lenticular lenses that is attached to the interlaced image and/or the quality of the printing of the interlaced image.

According to another aspect of some embodiments of the present invention there is provided a network based lenticular printing that allows a user to use remote resources for processing a lenticular image. The embodiments disclose a method and a system that allow a user to use a client terminal, which is positioned in one geographical location, to select a sequence of images that is stored in another geographical location, to use a remote computing unit, such as a server, for the processing of the sequence, and to receive a segment, which is optionally suitable for creating a preferred lenticular image, at the client terminal.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

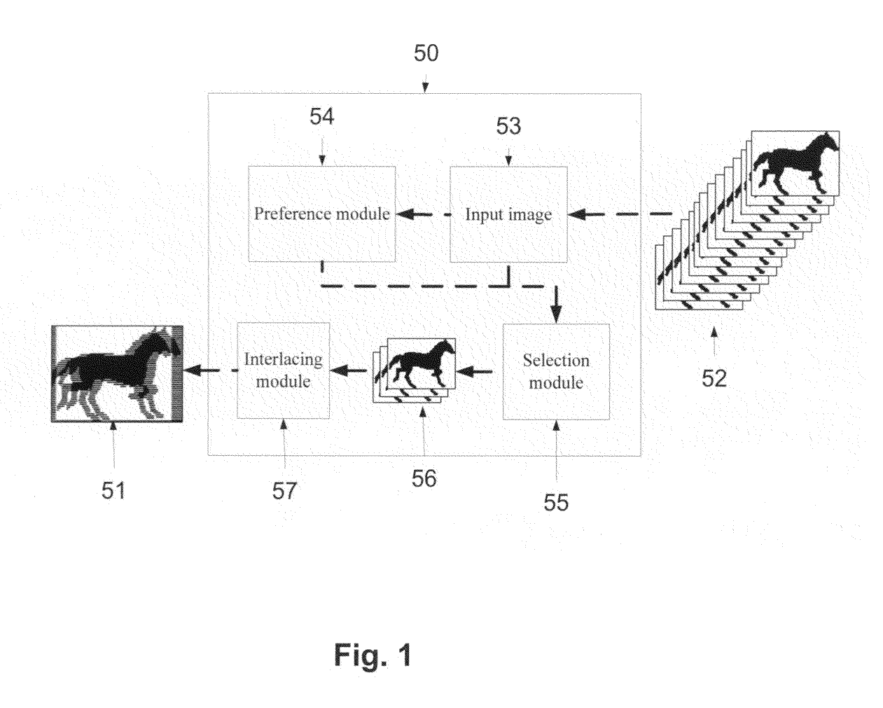

Reference is now made to FIG. 1, which is a schematic illustration of an apparatus 50 for creating an interlaced image 51 for lenticular printing, according to some embodiment of the present invention. The apparatus 50 comprises an input unit 53 that receives a number of images are provided, optionally in a sequence 52. As used herein, a sequence means a typical spatio-temporal signal such as a series of sequentially ordered images, a video sequence, or any other series of sequential images. The apparatus 50 further comprises a preference module 54 for defining and/or selecting one or more lenticular viewing measures which are related to lenticular viewing. The lenticular viewing measures may include one or more content measures, dynamics measures, and/or quality measures. The preference module 54 may select one or more lenticular viewing measures according to inputs which are received from the user of the apparatus and/or automatically according to characteristics of the received sequence 52. Optionally, preference module 54 provides a fixed set of lenticular viewing measures.

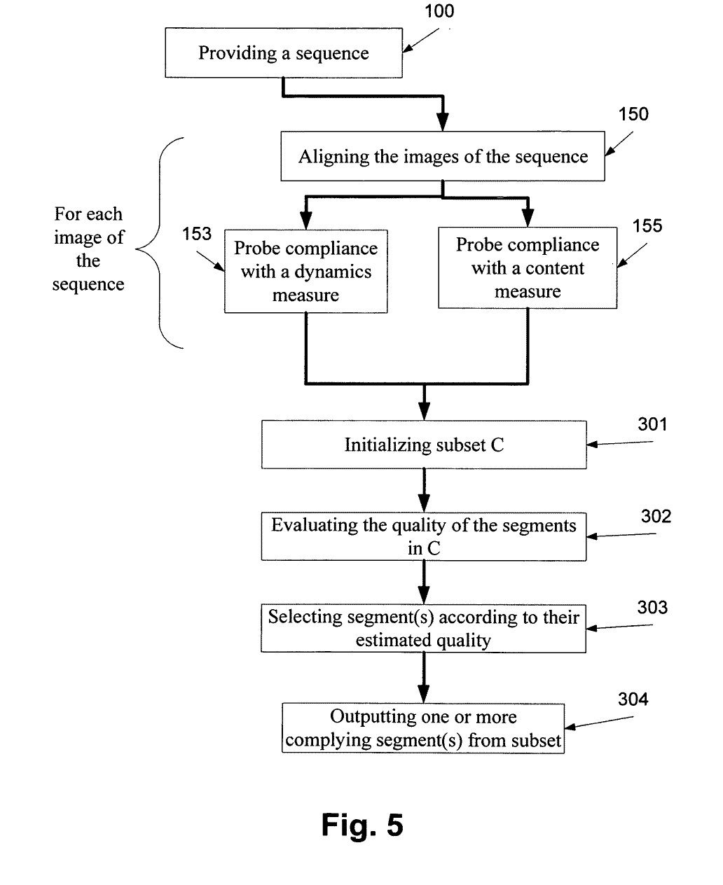

The lenticular viewing measures and the sequence 52 are forwarded to a selection module 55 that identifies a segment 56 of the sequence 52 that comply with the forwarded lenticular viewing measures. The one or more complying segment 56 is forwarded to an interlacing module 57 that interlace the interlaced image 51 therefrom. As used herein a segment means a series of images which are taken from the sequence 52. The series may include a predefined number of images or an arbitrary number of images, optionally as described in relation to FIG. 5 below.

It should be noted that the interlacing module 57 is not limited for generating interlaced images from spatio-temporal sequences and can be used in other lenticular printing applications, such as generating three dimensional images.

Furthermore, it should be noted that though the embodiments which are disclosed hereinbelow are described with reference to lenticular viewing, printing, and/or, images, they are not limited to lenticular viewing, printing, and/or, images and can be used for other applications and technologies.

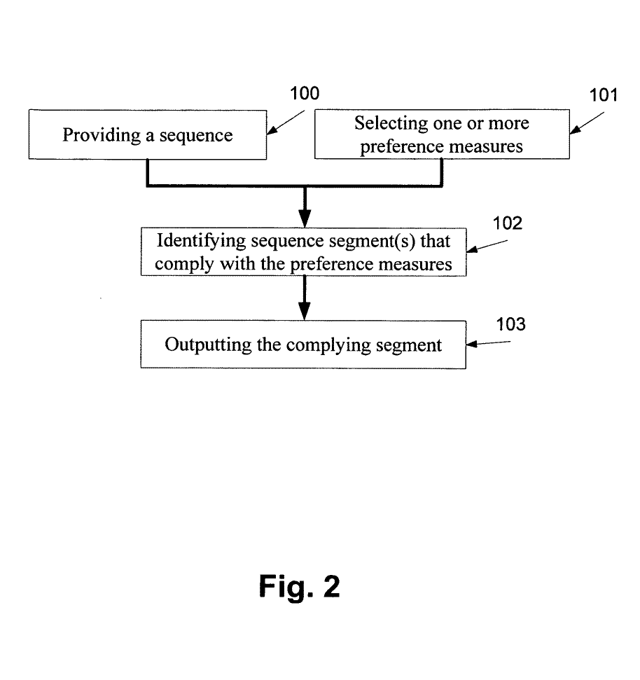

Reference is now also made to FIG. 2, which is a flowchart of a method for selecting a plurality of images for lenticular printing, according to some embodiments of the present invention. First, as shown at 100, the sequence 52 is provided. Then, as shown at 101, one or more lenticular viewing measures which are related to lenticular viewing are selected, optionally as described below.

Optionally, the user of the apparatus 50 bounds the sequence 52. Optionally, the user selects a frame, which is referred to herein as an anchor frame, that defines a center of the sequence which is probed in 102, the boundaries of the sequence, and/or the number of frames or the length of the sequence which is probed in 102. In such a manner, not all the sequence is analyzed and the computational complexity of method, which is depicted in FIG. 2, is reduced. Optionally, the apparatus 50 comprises a user interface for allowing the user to select a desired segment in the sequence 52.

After the lenticular viewing measures have been selected, as shown at 102, one or more segments of the sequence which comply with the lenticular viewing measures, for example as shown at 56, are identified. Optionally, the segments that comply with the lenticular viewing measures are weighted according to their level of compliance with the lenticular viewing measures, optionally as described below.

As shown at 103, one or more of the complied sequences, for example as shown at 56, are now outputted. Optionally, the outputted sequence is the sequence that has the highest level of compliance with the lenticular viewing measures. The output sequence is optionally forwarded to an interlacing module, such as shown at 57, that creates an interlaced image 51 for lenticular printing therefrom. Optionally, the interlaced image 51 is combined with a lenticular lens for generating a dynamic image. As used herein, a lenticular lens means a lenticular lens, an array of magnifying lenses, a set of lenticular lenses, and a parallax barrier.

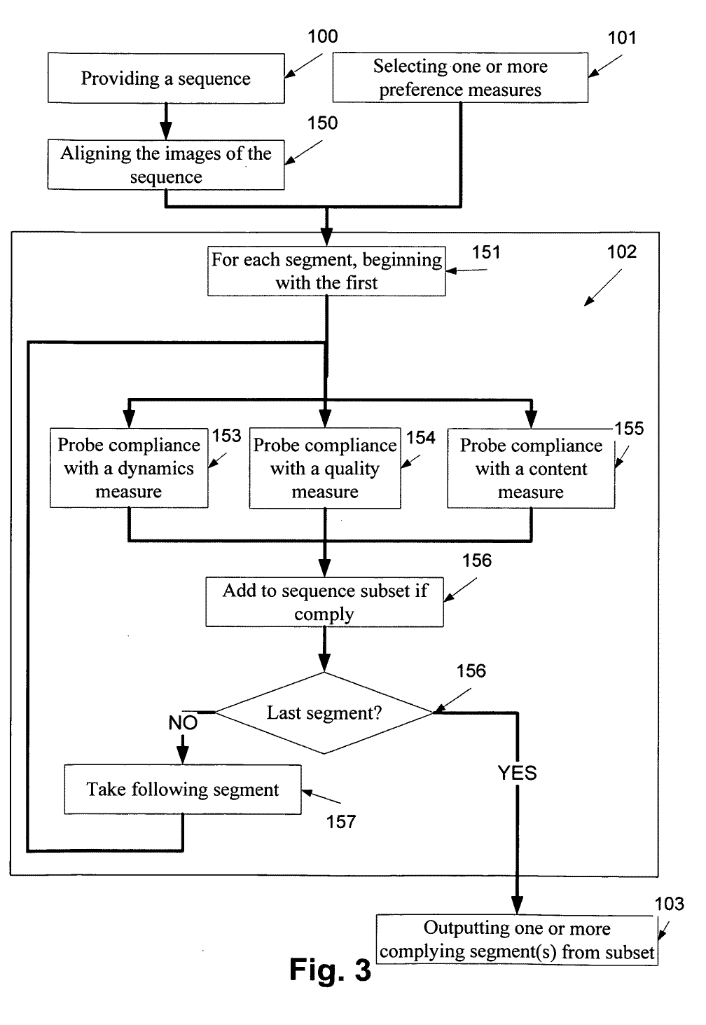

Reference is now made to FIG. 3, which is a flowchart of a method for selecting a segment of sequence for lenticular printing, according to some embodiments of the present invention. Blocks 100-103 are as depicted in FIG. 2, however FIG. 3 further depicts an exemplary process for identifying one or more segments that comply with one or more lenticular viewing measures and an additional block that depicts the aligning the images of the sequence before 102.

As shown at 150, after the sequence of images is provided, the images are aligned, optionally using an affine motion model. Optionally, the images are aligned as described in U.S. Pat. No. 6,075,905, filed on Jul. 18, 1997.

As shown at 102 and described above, after the sequence has been provided and aligned, a process for identifying segments that comply with one or more of the lenticular viewing measures begins. As shown at 151, the segments are optionally probed in a sequential manner. It should be noted that the compliance of the images of the sequence with one or more of the lenticular viewing measures may also be probed singly.

In some embodiments of the present invention, optionally as shown at 155, the lenticular viewing measures includes one or more content measures which are related to the content that is depicted in the images of the probed segment. In such an embodiment, the presence of an object with predefined characteristics is looked for in each one of the images of the segment. Optionally, a lenticular viewing measure is defined as the presence of a human face, a human body, a human organ, an animal face, such as the face of a pet, for example the face of a dog and/or a cat, an animal body, an animal organ, etc. Optionally, the presence of a young child is preferred over the presence of an adult.

In one exemplary embodiment of the present invention, the lenticular viewing measures include a content measure that is defined as the presence of an object with known characteristics, such as a human face and/or a pet face. In such an exemplary embodiment, for each image, a face detection process is implemented, for example as described in U.S. Pat. No. 7,020,337 filed on 22 Jul. 2002, which is incorporated herein by reference. Optionally, each image is tagged with a face presence tag, for example a binary value. Optionally, the methods which are described in FIGS. 1 and 3 includes a preliminary process in which a detection module which is used for detecting the presence of objects with known characteristics, such as faces and bodies, is trained. In such an embodiment, a face detection module is provided with a training set of labeled face images and optionally labeled non-face images and learns how to discriminate between them in an automated fashion, for example as described in E. Osuna, R. Freund, and F. Girosi. Training support vector machines: An application to face detection. CVPR, 1997; H. Rowley, S. Baluja, and T. Kanade. Neural network-based face detection, PAMI, 20:23-38, 1998; H. Schneiderman and T. Kanade. A statistical method for 3d object detection applied to face and cars. CVPR, 2000; and K. K. Sung, and T. Poggio, Example-Based Learning for View-Based Human Face Detection. PAMI, pp. 39-51, 1998, which are incorporated herein by reference.

In some embodiments of the present invention, optionally as shown at 153, the one or more lenticular viewing measures includes dynamics measures which are related to the dynamics that is depicted in the images of the sequence. In such an embodiment, the presence of a moving and/or a changing object in the image may be set as a lenticular viewing measure. Optionally, the lenticular viewing measures define a preference to a cyclic motion and/or change.

In one exemplary embodiment of the present invention, the lenticular viewing measures include a dynamics measure that defines a motion threshold or a motion range. While static or substantially static segments are not preferred for lenticular printing as they do not depict a motion that the lenticular image may emulate an image that depicts an object that has a motion vector above a certain level can be blurry. Optionally, each segment and/or image is weighted according to the motion level it depicts. For example, a number of motion ranges, such as a preferred motion range, a less preferred motion range, and an undesirable motion range, are defined and the compliance of the motion level that is depicted in the segment with each one of the ranges is weighted differently. Optionally, the level of motion in an image is a local motion that is calculated with respect to the following image, if available.

Optionally, the local motion is detected in a local motion identification process, such as an optic-flow algorithm, for example the optic-flow algorithm that has been published by A. Bruhn et al., see A. Bruhn et al. Real-Time Optic flow Computation with Variational Methods. In N. Petkov, M A. Westenberg (Eds.): Computer Analysis of Images and Patterns. Lecture Notes in Computer Science, Vol. 2756, Springer, Berlin, 222-229, 2003 and A. Bruhn et al., “Combining the advantages of Local and Global Optic flow Methods, L. Van Gool (Ed.), Pattern Recognition, Lecture Notes in Computer Science, Vol. 2449, Springer, Berlin, and in U.S. Pat. No. 5,680,487, filed on May 2, 1994, which are incorporated in their entirety by reference into the specification. In such an embodiment, the optic-flow which has been calculated for the probed image, optionally on the basis of the motion of an object with predefined characteristics is calculated in the light of the alignment of the image.

Optionally, the local motion is based on the motion of a moving and/or changing object with predefined characteristics. Optionally, the moving and/or changing object has known characteristics. For example, the lenticular viewing measure may be a changing human face in the image, a moving human body in the image, a changing animal face in the image, a moving animal body in the image, and a moving organ in the image.

As shown at 156, if the probed sequence complies with one or more of the selected lenticular viewing measures, it is added to a subset that includes segments that comply with the lenticular viewing measures. Optionally, each one of the segments is weighted according to the level of compliance thereof with the one or more lenticular viewing measures. As shown at 157, optionally all the segments of the sequence are probed. Optionally, each segment is ranked according its weight. The ranking reflects the compliance level thereof.

In some embodiments of the present invention, optionally as shown at 154, the lenticular viewing measures includes one or more quality measures which are related to the quality of the probed image of the sequence. In such an embodiment, the lenticular viewing measure may define a threshold of one or more predefined quality characteristics, such as a'blurring level, an image sharpness level, and an image brightness level. Optionally, a lenticular viewing measure defines a predefined level of motion that verifies that the probed image does not depict ghosting or ghosting above a predefined level.

After the compliance of the segments of the sequence with the lenticular viewing measures 153, 154, and/or 155 has been probed, the subset includes a list of segments is finalized. Each segment in the list is optionally weighted according to the compliance thereof with the lenticular viewing measures. In such a manner, the segment that complies with the lenticular viewing measures more than other segments of the sequence can be identified. Optionally, a set of segments is iteratively probed for identifying one or more segments that comply with the lenticular viewing measures.

As described above, one or more of the complying segments are forwarded to an interlacing module, for example as shown at 57 that interlaces the images of the sequence to generate the interlaced image. Optionally, the user selects which one or more segments are forwarded to the interlacing module for printing. Optionally, a predefined number of images is selected from each segment, for example 7, 8, 9, or 10. Optionally, a predefined number of images separate between the selected images, optionally, 5, 10, 15, 20, and 25 images separate between the selected images. Optionally, the images are aligned before they are forwarded to the interlacing module. Optionally, a finer global alignment process is applied to the images of each selected segment, for example as described in U.S. Pat. No. 6,396,961 filed on Aug. 31, 1998 or U.S. Pat. No. 6,078,701 filed on May 29, 1998, which are incorporated herein by reference. The alignment is optionally based on the print quality, for example as described below.

Optionally, the number of images in the sequence is arbitrary. Optionally, the interlacing module 57 selects the images for interlacing according to an image selection sub-process. For clarity, L denotes the number of images in a segment that includes a series images I₁, . . . , I_{L} and d denotes the resolution of the printer that is used for printing the interlaced image in dots per inch (DPI) units, p denotes the pitch of the lenticular lens that is attached to the interlaced image in lenses per inch (LPI) units, and K denotes the outcome of the function ceiling(d/p), round(d/p), floor(d/p) or any combination thereof.

Optionally, a set of K images is selected by sampling the sequence of images linearly. Optionally, a set of more than K images is selected, preferably at least 2*K frames. In order to allow the interlacing of the at least K images, the images are interlaced into a second resolution to create image I. Optionally, the second resolution is defined as follows: c=L*p.

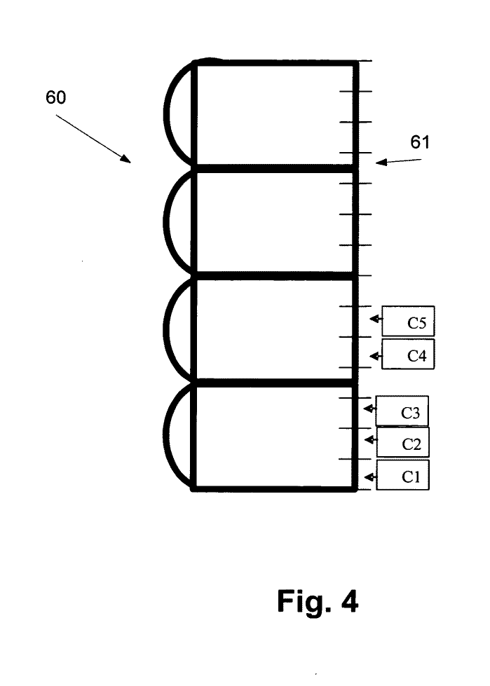

Then, image I is re-sampled, for example using bilinear interpolation by factor of d/c to create an image whose resolution is d. This approach reduces the blur of the interlaced image since it reduces the interpolation error. For clarity, reference is now made to FIG. 4, which is a sectional view of a lenticular image which is generated using an interlaced image which is generated as described above.

FIG. 4 depicts a sectional view of an exemplary array of lenticular lenses 60 and an array of physical pixels 61 which is optionally printed on the back side of the lenticular lenses 60. Optionally, the pitch of the lenticular lenses 60, does not divide the printing resolution. As a result, the number of physical pixels under each lens, which equals to the ratio d/p, is not an integer.

Optionally, the first pixel of each group of pixels which is printed or situated below a certain lens is an interpolation of one or more images. For example, if the number of images in the segment is four and the d/p equals to 3.5, for example as shown at FIG. 4, the interlacing process takes pixel C1 from the first image, pixel C2 from second image, and pixel C3 from the third image 3. Pixel C4, which is positioned below the edges of two lenticular lenses, is associated with the image between images 1 and 2 or shifted by a respective fraction of a pixel. Optionally, C4 is obtained by interpolating between image 1 and image 2, for example using bilinear interpolation or nearest-neighbor interpolation. Such interpolation causes blur and/or other artifacts, depending on the type of interpolation used. In one embodiment of this invention, the artifacts are reduced by using a larger number of images than dip. For example, in FIG. 4, 2d=7 images are sufficient. In this example, pixel C1 is taken from image 2, pixel C2 taken from image 4, pixel C3 taken from image 6, pixel C4 from taken from image 3 and so forth. Optionally, the maximal number of images is 10d/l.

Optionally, this image selection sub-process is optimized for reducing the computational complexity thereof. For example, with vertical lens directions, the interlacing to resolution c and the re-sampling to resolution d is performed separately on each image row. In such a manner, the need to store the image in resolution c is avoided.

Optionally, the images for interlacing are selected based on a quality criterion. Optionally, Z images with the highest quality are selected out of I₁, . . . , I_{L}. Each Image Zⱼ is selected to be the image of the highest quality among images I_{┌2hj┐}, . . . , I_{└2hj+h┘} where 0<=j<Z, h denotes 0.5*Z/L, and ┌ ┐, └ ┘ respectively denotes the ceiling and floor operators.

Optionally, the highest quality is measured by a maximal sum of the image gradients norms. The sum is defined as follows:

$${\sum }_{x , y} {‖ ∇ {I}_{j} ( x , y ) ‖}_{2}^{2} \qquad Equation 1$$

Reference is now made to FIG. 5, which is a flowchart of an exemplary process for selecting a segment of a sequence for lenticular printing, according to some embodiments of the present invention. Blocks 100, 150, 153, and 155 are as depicted in FIG. 3 however the process of identifying a segment that complies with the lenticular viewing measures, optionally more than other segments of the sequence, is performed in a different order.

After the sequence is received and aligned, as described above and shown at 100 and 150, the images of the sequence are probed. As shown at 155 and described above, the compliance if each one of the images of the sequence with a content measure is probed. Optionally, each image that does not depict an object with known characteristics, such as a human face is tagged as an irrelevant image. Each image is associated with a binary tag that indicates whether the respective image comply with the content measure or not. For clarity, the binary tag is defined as Fₛ where s denotes sequential index of the image which is associated with the tag.

As shown at 153 and described above, the compliance if each one of the images of the sequence with a dynamics measure is probed. Optionally, the optical flow of the image, which is optionally calculated as described above, is associated with the image. For clarity, the optical flow at image index s is defined as follows: Mₛ(x,y)=(u(x,y),v(x,y)).

Optionally, such an optical flow is computed for images which are already aligned and warped by a global motion alignment process.

Now, as shown at 301, an empty subset C is initialized. C denotes a set of segments; each segment is defined by a first image and a last image. Optionally, C⊂ R×R where R denotes the number of images in the provided sequence. C is initialized according to the outcomes of 153 and 155, optionally according to the following loop:

$$Equation 2 \\ FOR a = 1 to R \\ FOR b = a + T 1 to a + T 2 \\ IF {F}_{s} = 1 in any of {I}_{a} , … , {I}_{b} ; and \\ IF \frac{1}{s} {\sum }_{s , x , y} {‖ {M}_{s} ( x , y ) ‖}_{1} > {M}_{min} \\ THEN Tag {C}_{( a , b )} as a member of the subset C . \\ End FOR \\ End FOR \qquad$$

where (a,b) denotes a member of C. a denotes the first image of the segment, b denotes the last image of the segment, Iₓ denotes an image that is in position X in the sequence, Mₘᵢₙ denotes a minimum required motion, Iₐ, . . . , I_{b} denote all the images between Iₐ and I_{b}, and T₁ and T₂ denotes parameter which are defined to determined the number of images between the probed images. Optionally, T₁ and T₂ are set to be the number of images which have been captured during half a second and three seconds respectively. Optionally, Mₘᵢₙ is adjusted in advance to the source of the sequence, optionally to the type and/or the properties of the camera which is used for capturing the sequence.

Segments that depict motion and in one or more objects with predefined characteristics are tagged as members of C. Static segments and/or segments that do not depict objects with predefined characteristics are not tagged as members of C.

Now, as shown at 302, the quality of each one of the segments on C is evaluated. Optionally, a cost function, which is based on sharpness, contrast and motion blur in the final interlaced image is applied to each one of the segments. It should be noted that applying the cost function, which is described below, on the members of C usually has a lower the computational complexity than applying the cost function on all the possible segments of the sequence. The initialization of C reduces images which are not adjusted for lenticular printing.

For each member of C, the following equation that measures the quality of the final printed image is calculated as follows:

$${E}_{quality} ( a , b ) = {\sum }_{x , y , 0 \leq s < K} α {‖ ∇ {Q}_{s} ( x , y ) ‖}_{2}^{2} + ‖ \frac{{Q}_{s + 1} ( x , y ) - {Q}_{s} ( x , y )}{{‖ ∇ {Q}_{s} ( x , y ) ‖}_{2}} ‖ \qquad Equation 3$$

where α denotes a weighing value which is optionally adjusted by the user and Qₛ denotes a soft proof view between Q₀, . . . , Q_{K}. As used herein a soft proof view means a simulation of the printed image that includes the blurring effects of the lenticular print. A description of a computational process to produce a soft proof is provided below. The left side of the equation is determined according to the sharpness level of the simulated printed image and the right side of the equation is determined according to the motion which is depicted in the simulated printed image. Optionally, α is adjusted during a preliminary process to determine whether to give more weight to the sharpness quality in relation to the motion blur level or not.

Optionally, Q₀, . . . , Q_{K} are extracted by:

a) interlacing the images between Iₐ and I_{b} to create an interlaced image for a dynamic image, an interlacing process is know in the art and is based on the pitch of lenticular lens and the number of lenticules in the lenticular lens; and

b) convolving the interlaced image with a soft proof filter, which is optionally created as described below, and then extracting soft proof views are optionally spread linearly across the entire field of view of the lenticular lenses such that Q₁=Q_{K};

whereas the views with the simulated blur are optionally calculated by de-interlacing the blurred interlaced image. Briefly stated, each view is extracted by collecting and/or interpolating the relevant columns from the blurred interlaced image. Given the association of the interlaced image to a lens, the association of a view point to columns in the interlaced image is straightforward and therefore not further described herein. Such an association may also be used in the interlacing process. It should be noted that the blur may be approximated convoluting a linear shift-invariant blur filter.

As described above, optionally at least one of the selected segments is forwarded to an interlacing module that generated an interlaced image accordingly. Then, the interlaced image is printed and attached to a certain lenticular lens. The convolution of the soft proof filter emulates the blur which is caused by the printer of that interlaced image, by the quality of lamination of the interlaced image, and/or by the lenticular lens that is about to be attached to the interlaced image. Briefly stated, the convolution blurs the image according to an estimation of the blurring which is depicted in a prospective lenticular image that may be generated from the members of the segment.

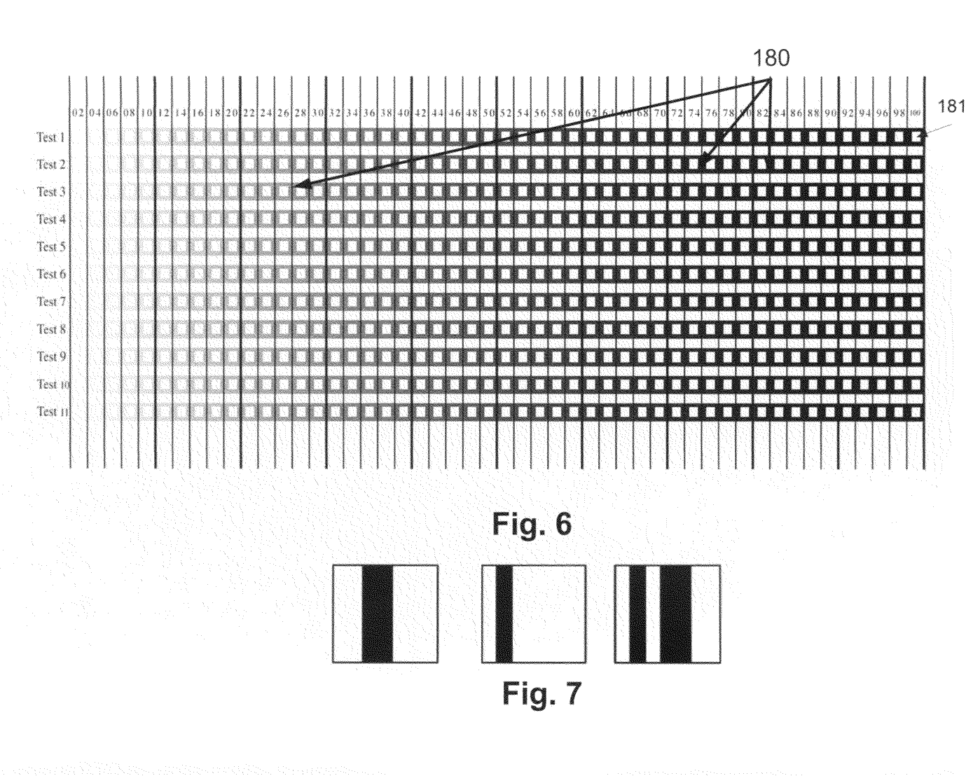

A soft proof filter is optionally generated using a calibration pattern, for example is shown at FIG. 6. Optionally, the calibration pattern is printed with a printing system that is substantially similar to the printing system that will be used for printing the final interlaced image. The calibration pattern is placed on the back side of a lenticular lens which is similar or substantially similar to the lenticular lens to which the interlaced image that is based on the outputted subset is attached. Each white square of the calibration pattern, for example shown at 181, is replaced with a template. The calibrator, which is a human user or an intensity measuring device, is asked to view templates through the lenticular lens, and identify, in each row, the column in which the template is indistinguishable from the related surrounding frame. FIG. 7 depicts schematic illustrations of exemplary templates according to some embodiments of the present invention. Optionally, the calibration pattern is printed directly on the back side of the lenticular lens or on a media which is placed closed to the back side of the lenticular lens, optionally in a similar manner to the manner that the final interlaced image is printed. Then a set of measurements is visually and/or optically evaluated. This measuring allows the creation of the soft proof filter. The soft proof filter is based on the measurements and on additional information such as the resolution if the printer which is used for printing the pattern, the pitch of the lenticular lens, etc.

Optionally, the calibration pattern depends on the print effects that need to be simulated. FIGS. 6 and 7, for example, simulate inter-views and intra-views blurring effects. The measurement process consists of a set of measurements, each associated with a test. FIG. 6 depicts an example of six tests or six measurements. For each test, a different pattern is printed within borders of different intensities, as shown at 180. Once the pattern is placed at the back of the lenticular sheet, a user identifies, for each test or row, the column for which the effect of the lenticular lens causes the internal rectangle to have the same apparent intensity as the surrounding boundary. If several such columns exist, the calibrator may pick one of the columns, for example the median column, or provide all columns as an output. This column represents the estimated quality of the lenticular intensity of the test, as if the user measures intensity.

It should be noted that the appearance of the calibration pattern depends on the viewing location of the user or the automatic pattern recognizer. Optionally, the calibrator receives an indication of the locations from which they are supposed to perform the measurements in every one of the iterations. The calibration pattern may then include templates that help the user localize to this position. Using such templates for localizing a center view is a standard technique in lenticular printing which is known to the skilled in the art and therefore note further described herein.

Optionally, the calibration pattern includes a template that assists the calibrator to identify its location. In such an embodiment, the calibrator provides location identification together with the measurements. Such location identification can be performed, for example, by printing several views interlaced, and asking the user to identify which view she sees.

The convoluting of the soft proof filter creates a visualization of the related interlaced image as if it is seen via a lenticular lens. For clarity, it should be noted the visualization can take various forms. Optionally, the views can be presented in by animating the views, where each view is adjusted to include the effects of the lenticular print and/or lens. Optionally, the views can be presented in anaglyph image that includes the simulated effects of the lenticular lens, for example as described in U.S. Pat. No. 6,389,236, filed on Feb. 1, 2000. Optionally, the views can be presented as a printout of views or as an anaglyph that includes the simulated effects of the lenticular lens.

Reference is now made, once again, to FIG. 5. As described above, the identification of segments that comply with the lenticular viewing measures may include a preliminary process in which a detection module is used for detecting the presence of objects with known characteristics, such as faces and bodies, is trained. Optionally, a database that stores a set of image sequence segments that has been selected in the past and/or added as sample image sequence segments is used.

In such an embodiment, the quality of each segment is evaluated using the following equation:

$${min}_{( c , d ) ∈ D} ( - {E}_{quality} ( a , b ) + λ {‖ H ( a , b ) - H ( c , d ) ‖}_{2}^{2} ) \qquad Equation 4$$

where E_{quality} is defined as Equation 3 and λ is set according to a few segments of the database and/or from other sources. The setting may be performed manually and/or automatically. Optionally, when the setting is performed manually, a set of sequences is selected, some of which containing segments that are similar to segments in the database. In such a manner, a user can select one or more segments for printing. Then, the segment detection algorithm is being executed for all the sequences for different values of λ. The user is presented with the results for each one of the values of λ. The user selects the value of λ that gives the best results. Optionally, when the setting is performed automatically, λ may be set with a value that brings both terms in Equation 4 to have the same variance over a given a set of segments.

The H_{(a,b)} is defined as a space time video descriptor which is based on the respective image, and accounts for local affine deformations both in space and in time, thus accommodating also small differences in speed of action, for example as described in E. Shechtman and M. Irani, Matching Local Self-Similarities across Images and Videos, IEEE Conference on Computer Vision and Pattern Recognition (CVPR), June 2007, which is incorporated herein by reference.

Now, as shown at 303, one or more of the segments that have the highest E_{quality} are selected and outputted 304. Optionally, these segments are forwarded to an interlacing module that creates an interlaced image for lenticular printing, optionally as commonly known in the art.

As described above, segments which are selected for print requires computing the Q images in Equation 3. Optionally, in order to reduce the computational complexity, K of the L are sampled linearly, as described above. Optionally, the interlaced image print and optionally a digital preview of the print, which is presented as described below, are used. The images are optionally selected according one or more of the follows:
1. A set of K images that is selected linearly, optionally as described above in relation to FIG. 3.
2. A set of K-2 images is selected linearly and the first and the last images are duplicated to get K images for interlace. In such an embodiment the blur between first and last images is reduced in the printed image.
3. All images in the sequence are used to get L images for interlace, optionally as described above in relation to FIG. 3.
4. All images in the sequence are used, while the first and the last images are duplicated, optionally round(L/K) times to get L+2*(round(L/K)−1) images for interlace.
5. K frames with the highest quality are selected, optionally as described above.
6. K−2 frames with the highest quality and a duplication of the first and the last images to get K images for interlace.
7. K/2 frames with the highest quality and each image duplicated to get K images for interlace.

Optionally, the cost of one or more of the abovementioned options is evaluated and the option that provides the optimal cost is selected.

As commonly known, lenticular printing may yield a lenticular image that combines between two or more images and a lenticular lens. The lenticular lens is designed so that when viewed from slightly different angles, different images are magnified. Most of the lenticular lenses induce a certain blur to the interlaced images. This blur depends on the relative motion between the combined images, specific parameters of the printing of the images, such as the printer resolution, the lens pitch, and/or the optical aberrations of the lens.

As used herein, optical aberrations means monochromatic aberrations, chromatic aberrations, or any combination thereof, monochromatic aberrations means an aberration produced without dispersion, such as piston, tilt, defocus, spherical, coma, astigmatism, curvature of field, and image distortion, aberrations, and chromatic aberrations means aberrations produced where a lens disperses various wavelengths of light, such as axial, or longitudinal, chromatic aberration and lateral, or transverse, chromatic aberration.

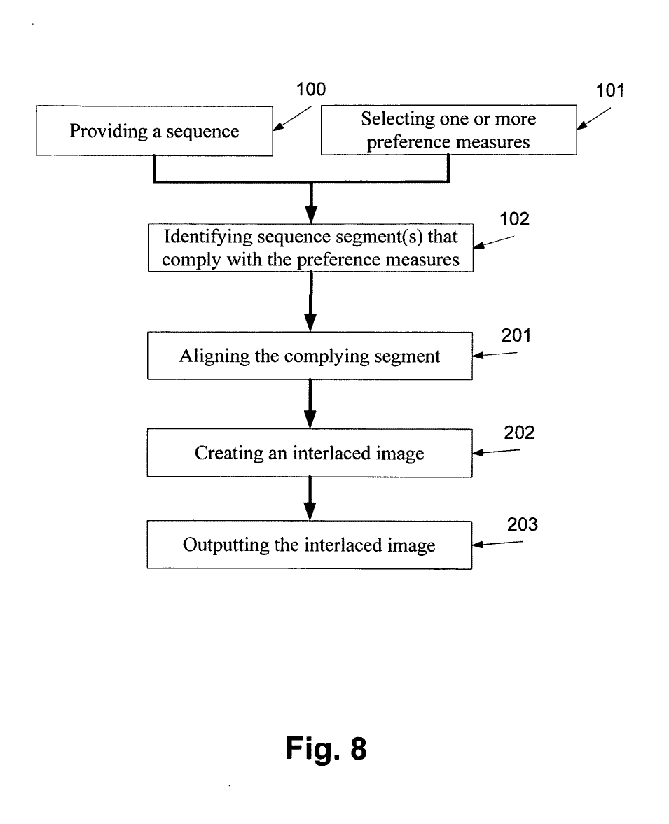

Reference is now made to FIG. 8, which is a flowchart of a method for generating an interlaced image for a lenticular image, according to some embodiments of the present invention. Blocks 100-102 are as described in FIG. 2. However, FIG. 8 further depicts blocks 201-203 which are designed for processing the complying segment, which is identified in 102, to produce an interlaced image that can be combined with a lenticular lens. The combination of the interlaced image and the lenticular lens produces a dynamic image, optionally as described above.

In one embodiment of the present invention, as shown at 201, after a segment that comply with the lenticular viewing measures is selected, as shown at 102, the images thereof are aligned. The alignment is designed to reduce the blur that is induced by the lenticular lens and optionally to increase the continuity of the animation that is created by the dynamic image that combines the images of the subset.

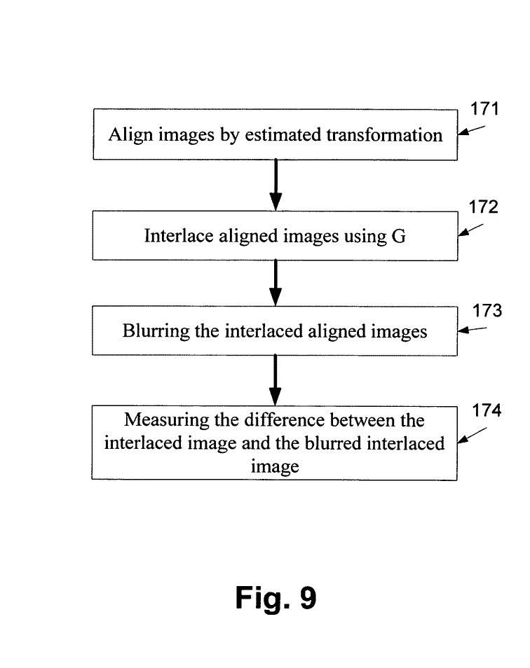

Reference is now made to FIG. 9, which is a flowchart of a method for aligning a series of images, such as the images of the segment which is described above, according to some embodiments of the present invention.

As commonly known, aligning images before the interlacing thereof reduces the blur of the interlaced image. Usually, the alignment of images is performed in a manual manner and therefore limited to simple transformation such as shift and rotation. The method which is described in FIG. 9 allows the identification of an accurate alignment that is critical for reducing the blur in of the interlaced image. The accurate alignment is based on complex non-rigid transformations, such as affine and projective transformations, which are performed in an automatic manner.

As depicted in FIG. 9, the alignment is based on a number of stages. First, as shown at 171, initial transformation estimation is calculated for each image. For clarity, N denotes the number of images in the segment, I₁(x,y), . . . , I_{N}(x,y) denote the images in the segment, I denotes an interlaced image, T₁, . . . , T_{N} denotes a set of transformations where each Tₓ is designed to align a respective Iₓ, G denotes a linear mapping of a set of N images F₁, . . . , F_{N} to an interlaced image I, I=G(F₁, . . . , F_{N}), and I_{K} denotes a reference frame that has the identity transformation and can be any one of the images. Optionally, the frame in the middle of the sequence, and T⁰₁, . . . , T⁰_{N} denotes a set of transformations where each T⁰ₓ, is initial transformation estimation for a respective Iₓ. Optionally, the initial transformation estimation is calculated according to a standard image alignment algorithm, for example as described in U.S. Pat. No. 6,396,961 filed on Aug. 31, 1998 or U.S. Pat. No. 6,078,701 filed on May 29, 1998, which are incorporated herein by reference.

According to the cost function for the invented alignment algorithm, as shown at 172, a set of interlace aligned images is generated using G to get the interlaced image I. The interlaced aligned images are blurred, as shown at 172 and described below, which considers the blurring that is caused by the lenticular lens and/or by the printer of the interlaced image. Then a sum of squared differences between the blurred interlace image and the interlaced image without the blur is calculated. This comparison is mathematically formulated as a convolution of the interlaced image with the blur function ƒ minus a delta function.

For example, then the following function is minimized as follows:

$${min}_{{T}_{1} , … , {T}_{N}} {\sum }_{x , y} {( ( G ( {T}_{1} ( {I}_{1} ) , … , {T}_{N} ( {I}_{N} ) ) * ( f - δ ) ) ( x , y ) )}^{2} \qquad Equation 5$$

where T_{K} denotes the identity transformation, δ denotes a delta function, and f is a filter that simulates the blur caused by the lenticular lens and/or the printing of the images, optionally as the aforementioned soft proof filter. Optionally, f=[¼ ½ ¼] and δ is applied by convolving a respective identity element, for example as described in U.S. Pat. No. 5,434,416 which is incorporated herein by reference.

Optionally, f is estimated by measuring, optionally visually, the blur which is caused by the lenticular lens which is about to be attached to I and/or by the printing process of I₁ . . . I_{N}. An example of such a measuring process for the purpose of soft proofing is described above in relation to FIG. 5 and in U.S. Provisional Patent Application 60/891,512 filed on 9 Jan. 2007, which is incorporated herein by reference.

The minimization of Equation 5 is performed iteratively. The initial transformation estimations are used as initial estimations for the first iteration. Optionally, Equation 5 is iteratively repeated as long as the values of the estimated parameters are substantially similar to the parameters in a previous iteration. Optionally, the similarity is determined according to a threshold, such as an arbitrary threshold. For example, the threshold is defined as a stop criterion that verifies if there is less than a pixel difference between successive iterations when applying all transformations to the four corners of the image on all images.

For example, let p₁, p₂ p₃, p₄ be the four image corners such that p₁=(0,0) and p₄=(w, h) where w, h respectively denotes the image width and the image height. In such an embodiment, the stopping criterion of the threshold at iteration j is defined as follows:

∀i,∀s,∥Tₛ^{j}(pᵢ)−Tₛ^{j-1}(pᵢ)∥<1 Equation 6

where the coordinates image are measured by counting pixels.

The estimation of T^{J}₁, . . . , T^{J}_{N} at iteration j, given the estimations of T^{J-1}₁, . . . , and T^{J-1}_{N} at iterations j−1, is calculated by solving a set of equations on the parameters of the residual transformations and then concatenating the residual transformation to the estimations of the previous iteration to get the estimations of the current iteration. Optionally, the concatenating is performed according to a set of equations for affine transformations, as follows:

First, the images, which are referred to as I₁(x,y), . . . , I_{N}(x,y), are warped according to T^{J-1}₁, . . . , T^{J-1}_{N} to obtain W¹(x,y), . . . , W^{N}(x,y). For clarity, the spatial derivatives of the warped images are defined as follows:

$${W}_{x}^{s} = \frac{\partial {W}^{s}}{dx} , {W}_{y}^{s} = \frac{\partial {W}^{s}}{dy} \qquad Equation 7$$

It should be noted that using spatial derivatives of images in alignment algorithms is known in the art. Examples for such usages are provided in U.S. Pat. No. 6,252,975 filed on Dec. 17, 1998, U.S. Pat. No. 6,456,731 filed on Oct. 1, 1999, and U.S. Pat. No. 6,507,661 filed on Jan. 14, 2003 and Eero P. Simoncelli, “Design of Multi-Dimensional Derivative Filters, International Conference on Image Processing, pages 790-794, 1994, which are incorporated herein by reference.

Now, the difference transformations are defined as H_{S}=T^{j}ₛ ·(Tₛ^{j-1})⁻¹. According to the assumption that each affine transformation Hₛ may be described by six parameters, which are related to image points (x₁, y₁) and (x₂, y₂), as follows:

$$( \begin{matrix}Δ x \\ Δ y\end{matrix} ) = ( \begin{matrix}{x}_{2} - {x}_{1} \\ {y}_{2} - {y}_{1}\end{matrix} ) = ( \begin{matrix}{a}_{s}^{1} {x}_{1} + {a}_{s}^{2} {y}_{1} + {a}_{s}^{3} \\ {a}_{s}^{4} {x}_{1} + {a}_{s}^{5} {y}_{1} + {a}_{s}^{6}\end{matrix} ) \qquad Equation 8$$

It should be noted that other parametric transformations can be solved by replacing Equation 8 with an appropriate parameterization form. Optionally, the following approximation is used to estimate each image Wₛ under its corresponding affine transformation Hₛ:

$${W}_{s} ( x , y ) * l + \begin{matrix}( {W}_{s}^{x} ( x , y ) & {W}_{s}^{y} ( x , y ) ) ( \begin{matrix}Δ x \\ Δ y\end{matrix} )\end{matrix} \qquad Equation 9$$

where l denotes a smoothing filter that is matched with the regularization in estimating the image spatial derivatives, for example as described as pre-filters pᵢ in Eero P. Simoncelli, “Design of Multi-Dimensional Derivative Filters”, International Conference on Image Processing, pages 790-794, 1994, which is incorporated herein by reference.

Equations 5,7, 8 allow the applying of a set of linear equations on the transformation parameters and the creation of an interlacing image, as shown at 202. Based on Equation 8 and 5, each image transformation Hₛ defines, for each pixel (x,y), the vector V as follows:

V,(x,y)=[xWₓ(x,y), yWₓ(x,y), Wₓ(x,y), xWₓ(x,y), yW_{y}(x,y), W_{y}(x,y), (W*l)(x,y)s] Equation 10

Now, for each transformation Hₛ or for each coordinate of Vₛ(x,y), create q images Dₛ^{j}:

j=1 . . . q,Dₛ^{j}(x,y)=Vₛ(x,y) Equation 11

with q=8. Then, as shown at 172, the images are interlaced to create q interlaced images

j=1 . . . q,Eⱼ(x,y)=G(D₁^{j}, . . . , D_{N}^{j}) Equation 12

Now images F^{j}ₛ are created, where for each of the size of the interlaced images Eⱼ the following loop is performed:

$$initialize ∀ x , y , j = 1 … q - 1 , \\ s = 1 … N , {F}_{s}^{j} ( x , y ) = 0 \\ forall x , y , j = 1 … q - 1 \\ s = {E}_{q} ( x , y ) \\ forall t suchthat ( f - δ ) ( t ) \neq 0 \\ {F}_{s}^{j} ( x - t , y ) = {F}_{s}^{j} ( x - t , y ) + ( f - δ ) ( t ) {E}_{j} ( x , y ) \\ endfor \\ endfor \qquad Equation 13$$

For clarity, it is assumed that the convolution filters f and δ are horizontal and therefore the lenticular lenses are vertical in relation to the interlaced image. It should be noted that other orientations may be used. Also, it is assumed that the interlacing process does not mix pixels from different views into the same pixel so that s is set from E_{q} in a unique manner.

Then, the set of equations on the transformation parameters is constructed as follows:

$$A [ \begin{matrix}{a}_{1}^{1} \\ ⋮ \\ {a}_{1}^{6} \\ ⋮ \\ \\ {a}_{N}^{1} \\ ⋮ \\ {a}_{N}^{6}\end{matrix} ] = b \qquad Equation 14$$

where A denotes a rectangular matrix and with the vector of unknowns that is multiplied with A excluding the parameters of the reference frame aₖ¹, . . . , aₖ⁶. Each coefficient in A corresponds to two parameters aₛ₁^{j1} and aₛ₂^{j2}. For example, both A₁₇ and A₇₁ correspond to parameters a₁¹ and a₂¹, which are located at the 1^{st} and 7^{th} coordinates in the vector of unknowns in Equation 14. The coefficient of A corresponding to each pair of parameters aₛ₁^{j1} and aₛ₂^{j2} is set to be the sum over all pixels x, y of F^{j1}ₛ₁(x,y)F^{j2}ₛ₂(x,y). Each coefficient of the vector b similarly corresponds to a coefficient aₛ^{j}. The coefficient of b corresponding to aₛ^{j} is set to be the sum over all the pixels of:

$${F}_{s}^{j} ( x , y ) ( {\sum }_{w = 1 . . . N} {F}_{w}^{7} ( x , y ) ) \qquad Equation 15$$

Reference is now made, once again, to FIG. 8. After the images have been aligned, they are warped according to the computed alignment transformations.

The warped images usually lack visual information. For example, a warp of an image that shifts the image to the right creates an image whose left side is missing. Optionally, such a lacking is handled by cropping the images to include only regions which are present at all the frames. Optionally, missing visual information is completed by a spatial extrapolation and/or by copying the information from one or more other frames. In one embodiment, the information is copied from a reference frame. In another embodiment, the information is an aggregation, such as the average or median, of the visual information from all frames that contain visual information in a respective pixel.

Then, an interlaced image is created therefrom, as shown at 202 and described above.

Then, as shown at 203, the interlaced image is outputted. By attaching the interlacing image to a lenticular lens a dynamic image that emulates a 3D perspective and/or a motion of one or more of the objects which are depicted in images of the aforementioned subset is created.

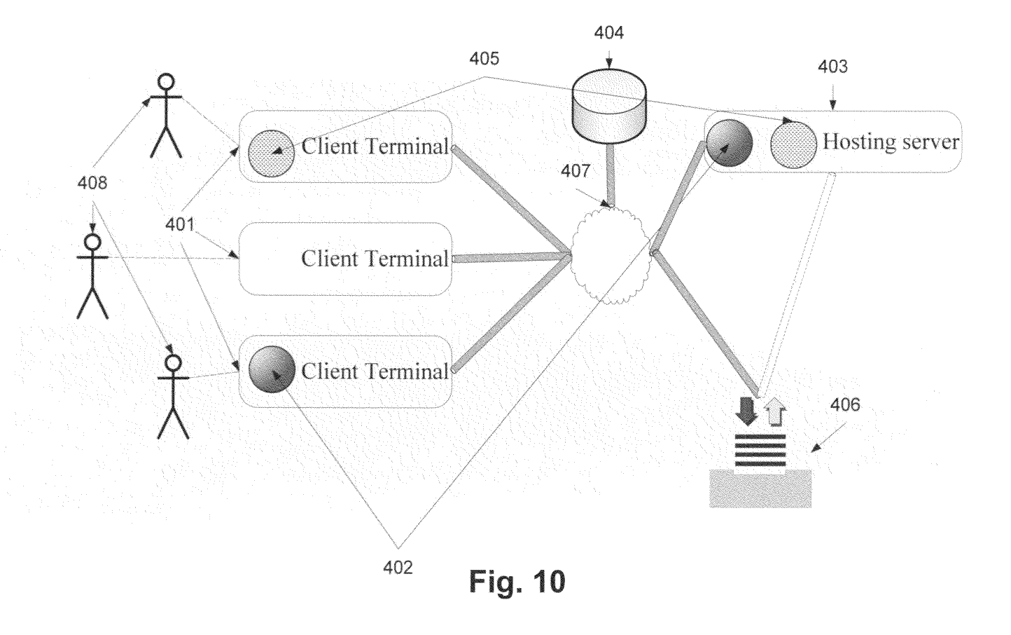

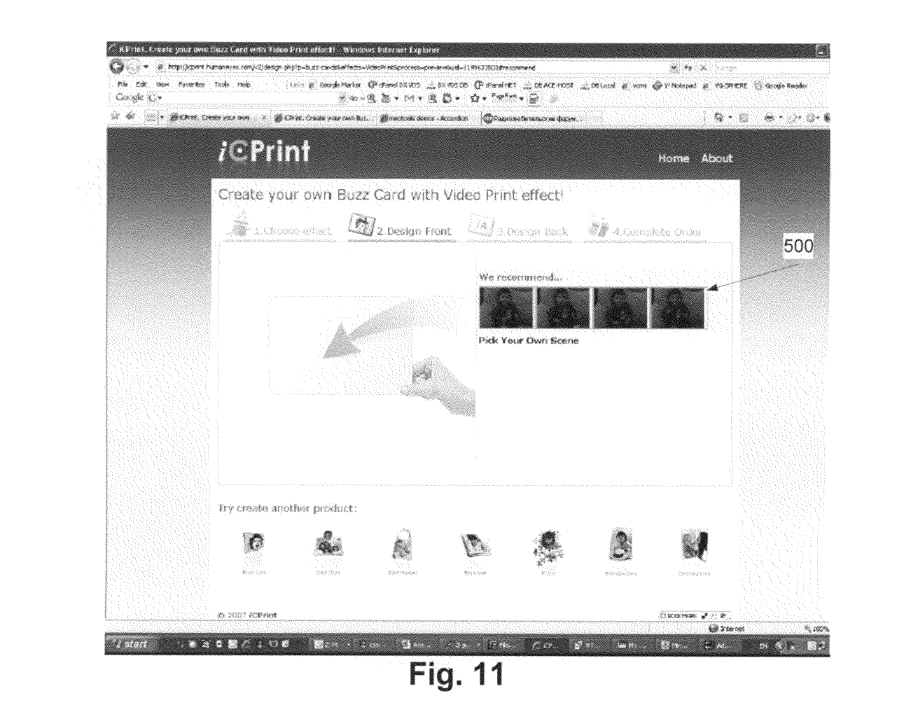

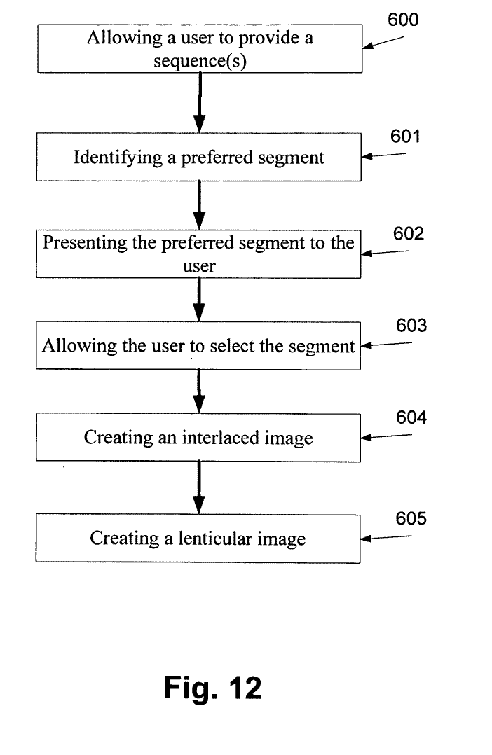

Reference is now made to FIG. 10, which is a schematic illustration of a system for generating a dynamic image and to FIG. 12, which is a flowchart of a method for generating a dynamic image, according to some embodiments of the present invention. The system comprises one or more client terminals 401 for allowing users to select one or more sequences, as shown at 600. As used herein a client terminal 401 means a personal computer, a server, a laptop, a kiosk in a photo shop, a personal digital assistant (PDA), or any other computing unit with network connectivity. The selected sequence is provided to a segment identification module 402. The segment identification module 402 may be hosted on the client terminal or on a remote network node 403 which is connected thereto via a network 407, such as the Internet. The segment identification module 402 identifies one or more preferred segments and present them to the user 408, as shown at 601 and 602. Optionally, the identified segments are presented to the user 408 on the display of the client terminal, for example as shown at FIG. 11, which is a schematic illustration of a user interface that allows the user 408 to select among a few identified segments, according to some embodiments of the present invention. In one embodiment of the present invention, the segment identification module 402 is hosted on a central server 403 and the user 408 establishes a connection therewith by accessing a designated website. In such an embodiment, the user 408 may upload the video segment, direct the segment identification module 402 to a storage 404 that hosts the video segment, and/or install a module that allows the identifying of one or more segments that comply with one or more of lenticular viewing measures, optionally as described in FIGS. 1 and 3.

Optionally, the user may use the client terminal 401 for adjusting the sequence. Optionally the user uses the client terminal 401 for bounding the sequence. Optionally, the user selects an anchor frame that defines a center of the sequence which is probed by the identification module 402, boundaries of the sequence, and/or a number of frames or a sequence length, optionally as described above.

Optionally, the user 408 adjusts the lenticular viewing measures which are used for identifying the segment. As described above, the segment can be performed by dynamics, content, and/or quality measures. Optionally, the user interface allows the user 408 to determine which lenticular viewing measures are used for identifying the segment and/or what is the weight of each one of the lenticular viewing measures.

Now, after the user 408 has been presented with the one or more of the identified segments, for example at shown at 500, the user 408 can choose one of the identified segments for dynamic imaging, such as lenticular printing, for example as shown at 603. Optionally, the user is presented with all the segments that have been weighted above a certain level, optionally as described above and/or with a predefined number of segments that have the ranked with the highest compliance level, optionally as described above. Optionally, the segments are presented in a hierarchical order. The hierarchical order is optionally determined according to the compliance of each segment with the one or more lenticular viewing measures which have been used for identifying it. In such a manner, the user receive an indication which one of the segments comply with the one or more lenticular viewing measures in the most efficient manner. Optionally, the user 408 is presented with a simulation of a lenticular image which is generated according to the presented segment. Optionally, the simulation is generated according to a soft proofing, such as the aforementioned soft proofing, that generates animated soft proof views.

As shown at 604, the selected segment is sent to an interlacing module 405 for creating an interlaced image. The interlacing module may be hosted on the client terminal or on a remote network node, for example as shown at 403. Optionally, the interlacing module 405 forwards the interlaced image to a printing unit 406 which is designed for printing lenticular image by combing between the interlaced image and a lenticular lens, for example as shown at 605. The printing unit 406 may be either connected directly to the hosting server 403 and/or via the network 407.

In one embodiment of the present invention, the user 408 uses the client terminal 401 for selecting a sequence and/or a segment, as described above. An interlaced image is created according to the selected segment and sent to a server which is connected to printing unit 406. The printing unit 406 prints a lenticular image that includes the interlaced image. Optionally, the interlaced image is mailed to the address of the user 408 or to any other address.

It is expected that during the life of a patent maturing from this application many relevant methods and systems will be developed and the scope of the term sequence, image camera, network, and communication are intended to include all such new technologies a priori.

As used herein the term “about” refers to ±10%

The terms “comprises”, “comprising”, “includes”, “including”, “having” and their conjugates mean “including but not limited to”.

The term “consisting of means “including and limited to”.

The term “consisting essentially” of means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub ranges as well as individual numerical values within that range. For example, description of a range such as from 1 to 6 should be considered to have specifically disclosed sub ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of selecting images for lenticular printing, comprising:
a) receiving a sequence having a plurality of images;
b) computing at least one lenticular viewing measure by processing said sequence;
b) selecting a group of at least some of said plurality of images according to said at least one lenticular viewing measure; and
c) outputting said group for allowing the lenticular printing.

2. The method of claim 1, further comprises weighting a plurality of groups of said sequence before b); each said group being weighted according to the compliance thereof with said at least one lenticular viewing measure, said selecting being performed according to said weighting.

3-5. (canceled)

6. The method of claim 1, wherein said at least one lenticular viewing measure comprises a member selected from a group comprising: a dynamics measure, a content measure, and a quality measure.

7. The method of claim 6, wherein said selected member is said content measure, said b) comprising selecting said group according to a member selected from a group comprising: a presence of a face in at least one image of said group, a presence of an object with predefined characteristics in at least one image of said group, a presence of a body organ in at least one image of said group, and a presence of an animal in at least one image of said group.

8. The method of claim 1, further comprises learning at least one characteristic of an object and said at least one lenticular viewing measure comprises a presence of said object and said c) comprises identifying said at least one characteristic in at least one image of said group.

9. The method of claim 6, wherein said selected member is said dynamics measure, said b) comprising identifying a motion characteristic in at least one image of said group.

10. The method of claim 9, wherein said b) comprising identifying an object having predefined characteristics, said motion being related to said object.

11. The method of claim 6, wherein said selected member is said quality measure, said b) comprising selecting said group according to a member selected from a group comprising: a blurring level of at least one image of said group, an estimated quality of the result of the lenticular printing, an image sharpness level of at least one image of said group, and an image brightness level of at least one image of said group.

12. The method of claim 1, thereby creating an interlaced image for the lenticular printing from images of said group.

13. (canceled)

14. The method of claim 1, wherein said selecting is performed according to a quality criterion pertaining to, an interlace image, based on said group, for the lenticular printing, said quality criterion being selected from a group consisting of: a blurring level, an image sharpness level, and an image brightness level.

15. The method of claim 6, wherein said selected member is said quality measure, said b) comprising probing a plurality of segments, further comprising for each said segment emulating a blur of a lenticular image generated from at least one image of said segment and weighting said blur, said b) further comprising selecting said segment according to said weighted blur.

16-17. (canceled)

18. The method of claim 1, further comprising allowing a user to select a sub set from said plurality of images, said selecting being performed from said subset.

19. The method of claim 1, further comprising allowing a user to select at least one anchor image from said plurality of images, said selecting being performed with reference to said at least one anchor image.

20-22. (canceled)

23. The method of claim 1, wherein said selecting comprises matching a plurality of segments of said sequence with a set of preferred segments where at least one of said set of preferred segments complies with respective at least one lenticular viewing measure, said group being selected from said plurality of segments according to said matching.

24. An apparatus for creating an interlaced image for lenticular printing, comprising:
an input unit configured for receiving a sequence having a plurality of images;
a preference module configured for computing at least one lenticular viewing measure according to said sequence;
a selection module configured for selecting a group of said sequence according to said lenticular viewing measure; and
an interlacing module configured for creating an interlaced image for lenticular printing from at least two images of said group.

25. The apparatus of claim 24, further comprising a database that stores a plurality of preferred segments and said selection module being configured for using said plurality of preferred segments for said selecting, wherein at least one of said plurality of preferred segments complies with respective at least one lenticular viewing measure.

26. A method for creating an interlaced image for lenticular printing, comprising:
a) receiving a sequence having a plurality of images;
b) automatically aligning a group of said plurality of images using a non-rigid transformation; and
c) outputting said aligned group for allowing the lenticular printing.

27. The method of claim 26, wherein said aligning is performed so as to improve lenticular printed image quality.

28-29. (canceled)

30. The method of claim 26, further comprising extending the field of view of at least one of the images before said c).

31-40. (canceled)

41. The method of claim 1, wherein said sequence is received at a first network node; further comprising d) sending said group to a second network node for allowing the lenticular printing.

42. The method of claim 41, wherein said first network node is a server and said second network node being a client terminal having a user interface.

43. The method of claim 41, further comprising displaying said group and receiving at least one of a confirmation for said displayed group and a selection of said group from a plurality of groups in response.
